(19) United States
(12) Patent Application Publication
(10) Pub. No.: US 2014/0178852 A1
(43) Pub. Date: Jun. 26, 2014

(54) Virtual Lesson Plan Integration

(71) Applicant: International Business Machines Corporation, Armonk, NY (US)

(72) Inventors: Gerald D. Colar, Mableton, GA (US); Melanie R. Diggs, Mableton, GA (US); John W. Miller, Suwanee, GA (US); Terrence E. White, Raleigh, NC (US); Charles K. Young, Powder Springs, GA (US)

(73) Assignee: International Business Machines Corporation, Armonk, NY (US)

(21) Appl. No.: 14/175,008

(22) Filed: Feb. 7, 2014

Related U.S. Application Data
(63) Continuation of application No. 12/983,508, filed on Jan. 3, 2011.

(51) Int. Cl. G09B 7/06; A63F 13/40

(52) U.S. Cl. CPC G09B 7/06; A63F 13/10
USPC 434/362

(57) ABSTRACT

A student personal computer (PC) presents educational questions at break points in a video game. It receives an identifier of a student. It receives a selection by the student of one of a plurality of video games, each of the video games including break points. It correlates the identifier of the student to a corresponding set of educational questions from a plurality of sets of educational questions. It begins execution of the video game. It, responsive to occurrence of a break point, interrupts the execution of the video game and render to the student playing the video game a question of the corresponding set of educational questions. It receives from the student an answer to the educational question of the corresponding set and determines whether the answer is correct. The student PC continues execution of the video game after receiving the answer from the student.

This application claims benefit of priority of patent application Ser. No. 12/983,508 (Attorney Docket number END920100196US1), filed on Jan. 3, 2011, which is herein incorporated by reference.

### BACKGROUND

The present invention relates generally to a computer implemented method, data processing system, and computer program product for interspersing educational testing with video game play. More specifically, the present invention relates to rendered question-answer sessions interspersed with video game execution.

Video games are well known today. A video game generates a video with characters and objects, and allows one or more (human) players to interact with the characters and objects in the video game and thereby influence the progression and outcome of the video game. Typically, the video game is generated by software executing on a computer and is animated. If there is more than one player, they can compete with each other in the environment of the video game. A single player can compete with the characters and objects in the video game. Often, the one or more player(s) obtain a score at the end of the video game indicating how well they competed.

There are a wide range of video games available today from such companies as Sony Corporation and Nintendo of America. Some video games mimic real-life sports and activities, and others create a made-up world, often with action characters in competition or combat with the players. While the main attraction of video games is entertainment, it was also known for the video game software to occasionally pause the video game, present predetermined educational questions to the player, and accept and analyze answers from the players to the questions. For example, U.S. Pat. No. 6,024,572 to Weyer disclosed a software module that can be incorporated into a game program's code or that can be loaded separately into a computer's memory. This module periodically suspends a game's play by popping up a “flash card” on the computer's display screen asking a question that must be answered correctly before play can be resumed. While the foregoing prior art was beneficial in combining educational questions with video game play, it would be beneficial to provide greater flexibility in the educational questions where presented.

U.S. Pat. No. 5,035,625 to Munson discloses that a student selects a game to be played and a teaching program retrieves the game program. The student selects one or more tutorials which shall be applicable for this game. After selection of the tutorials by the student, the teaching program retrieves the tutorials from the disk. The game begins. After each student has entered his game strategy, the first student is asked what difficulty level he wishes to select for his first question. The teaching program randomly selects an appropriate question of the selected difficulty level in the selected tutorial module. The teaching program determines whether the correct answer has been selected. The scoring algorithm for the game will be modified pursuant to the responses by the students to their respective questions. The game scoring algorithm is modified to permit a better score or higher score in response to positive or correct input from the student to the tutorial questions.

### BRIEF SUMMARY

The present invention comprises a computer system, program product and method for presenting educational questions at break points in a video game. A student personal computer (PC) presents educational questions at break points in a video game. It receives an identifier of a student. It receives a selection by the student of one of a plurality of video games, each of the video games including break points. It correlates the identifier of the student to a corresponding set of educational questions from a plurality of sets of educational questions. It begins execution of the video game. It, responsive to occurrence of a break point, interrupts the execution of the video game and render to the student playing the video game a question of the corresponding set of educational questions. It receives from the student an answer to the educational question of the corresponding set and determines whether the answer is correct. The student PC continues execution of the video game after receiving the answer from the student.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system in accordance with an illustrative embodiment of the invention;

FIG. 2 is a lesson plan in accordance with an illustrative embodiment of the invention;

FIG. 3 is a distributed system arranged in accordance with an illustrative embodiment of the invention;

FIG. 4 is a flowchart of video game in accordance with an illustrative embodiment of the invention;

FIG. 5 is a flowchart of lesson plan distribution in accordance with an illustrative embodiment of the invention;

FIG. 6 is a flowchart of a video game interaction with a student and lesson plan in accordance with an illustrative embodiment of the invention; and

FIG. 7 is a flowchart of steps of a lesson plan server in accordance with an illustrative embodiment of the invention

### DETAILED DESCRIPTION

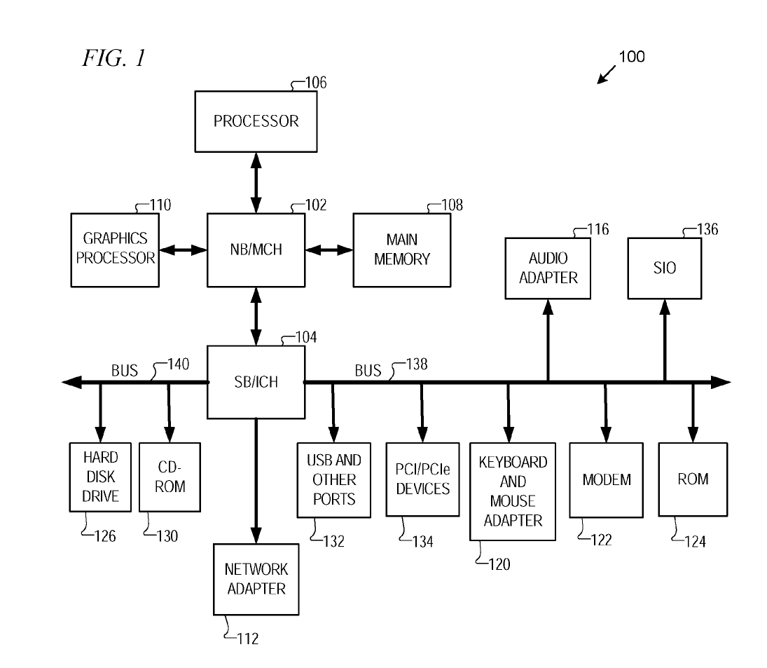

With reference now to the figures and in particular with reference to FIG. 1, a block diagram of a data processing system is shown in which aspects of an illustrative embodiment may be implemented. Data processing system 100 is an example of a computer, in which code or instructions implementing the processes of the present invention may be located. In the depicted example, data processing system 100 employs a hub architecture including a north bridge and memory controller hub (NB/MCH) 102 and a south bridge and input/output (I/O) controller hub (SB/ICH) 104. A north bridge is a chipset that facilitates communication between the processor and main memory. A south bridge is a chipset that facilitates communications from processor to and among drives and other peripherals. Processor 106, main memory 108, and graphics processor 110 connect to north bridge and memory controller hub 102. Graphics processor 110 may connect to the NB/MCH through an accelerated graphics port (AGP), for example.

In the depicted example, local area network (LAN) adapter 112 connects to south bridge and I/O controller hub 104 and audio adapter 116, keyboard and mouse adapter 120, modem 122, read only memory (ROM) 124, hard disk drive (HDD) 126, CD-ROM drive 130, universal serial bus (USB) ports and other communications ports 132, and peripheral component interconnect (PCI) and PCI express (PCIe) devices 134 connect to south bridge and I/O controller hub 104 through bus 138 and bus 140. PCI/PCIe devices may include, for example, Ethernet adapters, add-in cards, and PC cards for notebook computers. PCI uses a card bus controller, while PCIe does not. ROM 124 may be, for example, a flash binary input/output system (BIOS). Hard disk drive 126 and CD-ROM drive 130 may use, for example, an integrated drive electronics (IDE) or serial advanced technology attachment (SATA) interface. A super I/O (SIO) device 136 may be connected to south bridge and I/O controller hub 104.

An operating system runs on processor 106, and coordinates and provides control of various components including within data processing system 100 in FIG. 1. The operating system may be a commercially available operating system such as Microsoft® Windows® XP. Microsoft and Windows are trademarks of Microsoft Corporation in the United States, other countries, or both. An object oriented programming system, such as the Java™ programming system, may run in conjunction with the operating system and provides calls to the operating system from Java™ programs or applications executing on data processing system 100. Java™ is a trademark of Sun Microsystems, Inc. in the United States, other countries, or both.

Instructions for the operating system, the object-oriented programming system, and applications or programs are stored on computer readable tangible storage devices, such as hard disk drive 126, and may be read into main memory 108 for execution by processor 106. The processes of the present invention can be performed by processor 106 executing computer implemented instructions, which may be located in a memory such as, for example, main memory 108, read only memory 124, or in one or more peripheral devices.

Those of ordinary skill in the art will appreciate that the hardware in FIG. 1 may vary depending on the implementation. Other internal hardware or peripheral devices, such as flash memory, equivalent non-volatile memory, and the like, may be used in addition to or in place of the hardware depicted in FIG. 1. In addition, the processes of the illustrative embodiments may be applied to a multiprocessor data processing system.

In some illustrative examples, data processing system 100 may be a personal digital assistant (PDA), which is configured with flash memory to provide non-volatile memory for storing operating system files and/or user-generated data. A bus system may be comprised of one or more buses, such as a system bus, an I/O bus, and a PCI bus. Of course, the bus system may be implemented using any type of communications fabric or architecture that provides for a transfer of data between different components or devices attached to the fabric or architecture. A communication unit may include one or more devices used to transmit and receive data, such as a modem or a network adapter. A memory may be, for example, main memory 108 or a cache such as found in north bridge and memory controller hub 102. A processing unit may include one or more processors or CPUs. The depicted example in FIG. 1 is not meant to imply architectural limitations. For example, data processing system 100 also may be a tablet computer, laptop computer, or telephone device in addition to taking the form of a PDA.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable device(s) having computer readable program code embodied thereon.

Any combination of one or more computer readable device(s) may be utilized. Examples of a computer readable tangible storage device include a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible device that can store a program for use by or in connection with an instruction execution system, apparatus, or device. The term “computer readable storage device” does not include a signal propagation media such as a copper cable, optical fiber or wireless transmission media.

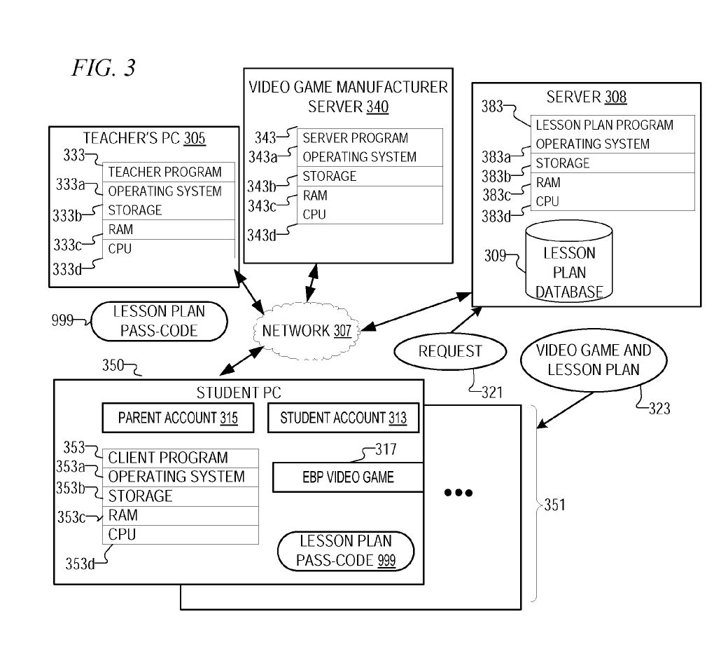

Program code may be downloaded to the respective computers of teacher's PC, student PC, and server, shown in FIG. 3, explained further below, via the Internet (i.e. routers, switches, firewalls, gateway computers, nodes, communication wires and optical fibers, wireless transmission, etc.).

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable device that can direct a computer, other programmable data processing apparatus, or other devices to function in a particular manner, such that the instructions stored in the computer readable device produce an article of manufacture, including instructions, which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The illustrative embodiments permit a parent or other guardian to restrict video game entertainment features of break point video games to correlate with a child's performance with respect to one or more lesson plans. In addition, a teacher may select among her preferred set of video games those that are to be matched with lesson plans correlated to students specified by the teacher, for example, by using a set of games available to her students. Thus, the teacher selects one or more sets of questions (or lesson plans) to ask students, named by the teacher, during play of any one of a wide variety of video games. A guardian may coordinate software installation and use with a child's teacher to assure that the child is progressing in learning and other tasks. In addition, self-directed students may develop their own lesson plans. As such, entertainment may be interspersed with education in such a way that entertainment rewards educational accomplishments.

According to the embodiments of the present invention, each video game has educational break points that can be used to present questions to different students for different lesson plans. Accordingly, students who play the same video game at different times on the same computer or at the same or different times on different computers and have differing curricula can be presented with different sets of test questions that are suited to them, for example, questions from the lesson plans created by their respective teachers for students in the teacher's class. As an example, a set of educational questions for a Geography class will be presented at the break points for any or all of a group of video games for students in this Geography class that utilize these video games (and identify themselves to the system before operating the video games), and another, different set of educational questions for a Math class will be presented at the same break points for any or all of the same group of video games for students in the Math class that utilize these video games (and identify themselves to the system before operating the video games). The students in the Geography class cannot obtain the educational questions correlated to the students in the Math class, and vice versa, unless the same student is in both classes.

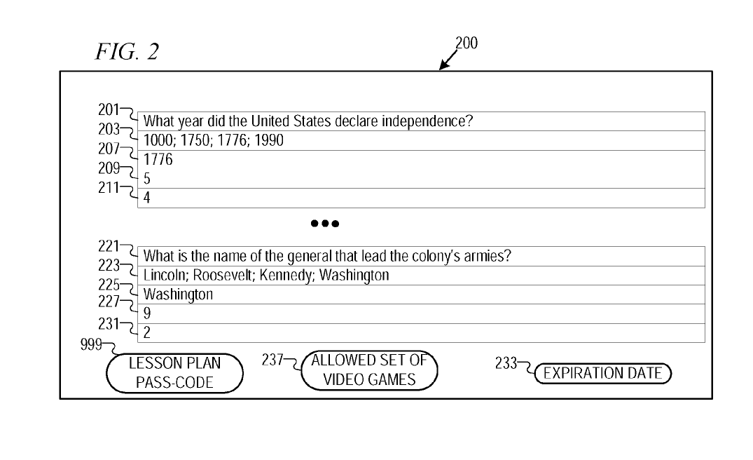

FIG. 2 is a lesson plan in accordance with an illustrative embodiment of the invention. The lesson plan may be developed on a personal computer or other suitable data processing system, for example, data processing system 100 of FIG. 1. The lesson plan can operate as a question and answer arrangement which can be used by a data processing system to present to a student educational questions by which the student's progress can be measured. An educational question is a question that corresponds to coursework that a student may study in K-12, graduate, vocational and post-graduate studies, to name a few.

A lesson plan is a sequence of questions that relate to a common subject. Lesson plan 200 includes a series of questions, including, “What year did the United States declare independence?” 201 and “What is the name of the general that lead the colonies' armies?” 221. A teacher provides a list of answers that include a correct answer, for example, lists 203, 223. A correct answer is the one or more answers that the teacher identifies as correct, and is subsequently stored to the repository as a correct answer. In addition, the educator or teacher may provide a correct answer, for example, answers 207, and 225. The educator can set a weight for a question such that a question may be scored with a larger value of points to obtain. The weights can be expressed in a priority order with one being equivalent to a heavy weight as compared to nine being equivalent to a relatively lower weight, for example, see weights 209, 227. Accordingly, an academic score can be generated for a series of questions. An educator is a person who's part time or full time job is to teach students.

An academic score can be a proportion of points given for correct answers divided by the number of points available for the sum of all questions answered. An academic score can be in relation to a single lesson plan. Alternatively, an academic score can be a sum or synthesis of the results from a student's responses to several lesson plans.

In addition to weights, the educator may assign a difficulty rating to each question. For example question 201 may have difficulty rating of four 211, while question 221 may have a difficulty rating of two 231. A difficulty rating is a determination of the educator that the educator applies to a question that corresponds to the educator's expectations of how easy a question is or a proportion of students who are expected to immediately know the answer. Consequently, the teacher may draw on her previous experience with students to develop a difficulty rating for a question. Alternatively, the teacher may rely on statistics or other objective measures of difficulty.

This approach permits parents and instructors to control the academic content presented in a video game for a particular student, thus preventing a student from using trivial lesson plans to undermine the quality of interaction with the lesson plan during game play. Consequently, the gaming system used by the student may be configured to allow the student to initiate play only after loading a valid lesson plan, as defined by a preconfigured list of valid lesson plan codes correlated to the student's name or other student identifier. In other words, the lesson plan code identifies a set of questions correlated to a teacher or a teacher's class, for example, as defined by the roster of students.

A student pass-code can be a unique identifier of the student, such as, for example, a student's name. As such, the student pass-code or the student's name (validated with a password) can be used to look-up lesson plans assigned to each of the students. Because different teachers can concurrently use the present invention to present their respective lesson plans/sets of educational questions to their respective classes of students, and the same students may be members of two or more of these classes, there is a lesson plan code for the teacher or the teacher's class to identify the lesson plan for the teacher or the teacher's class. The student can enter the lesson plan code when entering the student's identifier to identify the lesson plan(s)/set(s) of educational questions for that student for a specific class. The lesson plan code can be the teacher's name, name of the class or another code that the student obtains from a list of codes (correlated to the student's class) presented in the user interface when the student logs on to the system. Thus, the lesson plan pass-code may be associated with one or more student pass-codes, to limit the lesson plan(s) used for the student to lesson plan(s) specified by a teacher for the teacher's class.

In addition, an educator may set an expiration date 233 for a lesson plan. An expiration date establishes a final date on which the lesson plan may be selected for use with a video game. An educator may update this date to reflect that the educator is working with a new group of students at the beginning of a semester.

Optionally, a teacher can select or otherwise authorize specific video games to be among those that students may later choose to use with the lesson plan. This subset of video games is called allowed set of video games 237. Accordingly, for a given student, that student's pass-code may correspond to a set of lesson plans. Moreover, those lesson plans may correspond to a set of video games. Thus, when the student identifies herself to the server hosting the relations between student, lesson plan, and video game, the server can present a set of video games that are matched to the student—thus providing the student choices in video games to play.

Lesson plans may be configured and transmitted as flat files, XML files, or any file amenable to creating, modifying and transmitting data structures. When a teacher transmits a lesson plan to a server, such as server 308, as described below, the teacher may send with it, the lesson plan pass-code(s) 999, allowed set of video games 237, and expiration date 233.

FIG. 3 is an architecture of a computer network in accordance with an illustrative embodiment of the invention. An educator or teacher may work at teacher's PC 305 to edit a lesson plan associated with lesson plan pass-code 999. When the teacher completes forming the lesson plan, the teacher may store the lesson plan to a lesson plan repository, such as, for example, lesson plan database 309. Lesson plan database 309 may be reached over network 307, by making, for example requests 321 to server 308. A student may access lesson plan database 309 through the use of student PC 350 via network 307. The student, by using his student pass-code, provides the server information by which the server determines a list of lesson plans that are associated with the pass-code. The server can make this determination on the basis of a teacher's previous matching of student pass-codes (in some cases their names) to the one or more lesson plan pass-codes that the teacher controls. If two different teachers specified different lesson plans for the same student, then server 308 will prompt the student to enter the lesson plan code for the teacher or teacher's class that the student wants to answer. As explained above, the lesson plan code can be the name of the teacher or the teacher's class. Once the server has located lesson-plans associated to the student pass-code (and in some cases, the lesson plan code), the server can further lookup the set of allowed video games associated with each lesson plan, by using, for example, the set of video games previously defined in FIG. 2. Coordinated operations of the client and the server work to provide the student a list of games, and receive the student's selection of educational break point (EBP) video game.

This process may occur at the direction of the student, but in a transparent manner. In other words, the student may select a video game, and the operation of the student PC may respond by accessing lesson plan database 309, and an associated teacher-selected lesson plans with the video game. Additional students may use one or more student PCs 351, for example, located at their homes. Again, by choosing a video game, the second student drives the process that pairs the pre-selected lesson plan to the chosen video game on the basis of the student's identity.

Each student PC may have segregated authorizations which limit a student's power to access functionality of the student PC. Accordingly, the student is provided functionality specified in student account 313. A student account is an account that grants a student limited access to entertainment features of a student PC 350. For example, the student account can block all software installations to the student PC without approval by a guardian. Conversely, a parent or guardian of the student may have additional authority to operate the PC. As such, the parent is limited to the extent that the parent account 315 specifies.

The parent may coordinate use of the student PC 350 by adding or otherwise associating a lesson plan pass-code, such as lesson plan pass-code 999, to the student account 313. A pass-code can be a unique identifier of the student, such as, for example, the student's name. It is appreciated that multiple students may share a common student PC. Accordingly, each student account may be associated with a different lesson plan pass-code. Each of parent account 315 and student account 313 may authenticate users as authorized to access computer features, using, for example, passwords. Thus, the student PC may operate for any user who supplies the correct credentials for a student, thereby giving such a user the same access as the student. In contrast, the student PC may treat any user who supplies the correct credentials as the parent. A parent is any guardian of the student, and can include, for example, grandparents, uncles, and aunts, to name a few.

It is appreciated that a student that has an account that has equal or better authorizations to a parent account can also perform functions of the parent.

A student may obtain access to educational break point (EBP) video game 317. The educational break point is a point in the game where reflexes are not needed to advance game play. The video game defines these points as criteria, for example, when active game play ceases, as might happen when summing up a score, or introducing objective for next level of play. This point can happen because a simulated football has come to rest, in, for example, a football video game. This point can happen at the conclusion of a race. This point can happen when a player levels up. In order to take advantage of the popularity of currently existing video games, video game manufacturers can make video games to include educational break points to which different sets of educational questions can be presented. When a video game maker takes advantage of this extended functionality, any popular video game can become an EBP video game. Video game makers may make EBP video games so that the games offer a minimum number of educational break points. Such a minimum number or standard number may be set by convention as a number sufficient to cover a chapter, pop quiz, or any other unit of a book and/or teaching curricula. Accordingly, the student or parents can customize the EBP video game experience in coordination with educators.

EBP video game 317 may be installed to a student PC 350 by using disk devices, or alternatively, downloading the video game from video game manufacturer server 340. Server 308 may, alternatively, operate as an intermediary between student PC 350 and at least one video game manufacturer by obtaining video game and lesson plan and transmitting both as a video game and lesson plan stream 323 to the student PC. Each of student PC 350, teacher PC 305, video game manufacturer server 340, and server 308 may have programs, respectively, client program 353, teacher program 333, server program 343, and lesson plan program 383. Each of the described programs may rely on respective operating system 353a, storage 353b, random access memory (RAM) 353c and central processing unit (CPU) 353d of each data processing system. Details of the internal components of each of student PC 350, teacher PC 305 video game manufacturer server 340 and server 308 may, alternatively, be those of the representative data processing system 100 of FIG. 1. It is appreciated that more than one processor can function to operate plural threads of a single program. Accordingly, the specific hardware as shown, is merely an example of the many configurations that a suitable data processing system may take and still implement the illustrative embodiment(s).

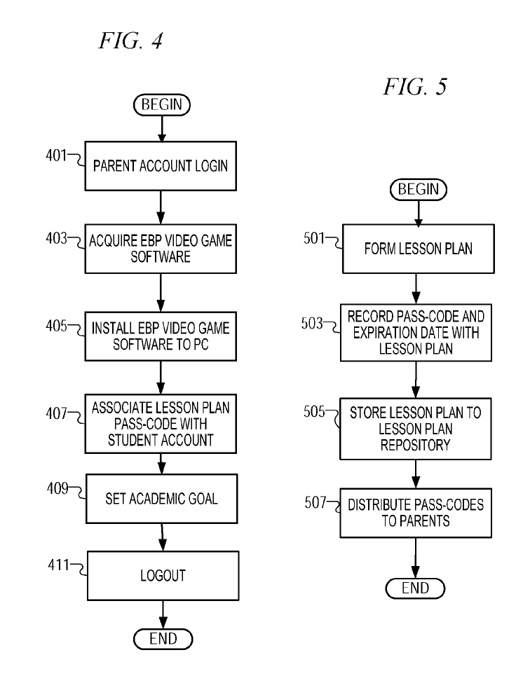

FIG. 4 is a flowchart of video game installation in accordance with an illustrative embodiment of the invention. The embodiment permits the student to be matched with a lesson plan and also to a video game, later, when the student begins playing the EBP video game. Client program 353 is stored in computer-readable disk storage 353b for execution by processor(s) 353d via computer readable RAM 353c (see FIG. 3). Initially, a student PC, executing, for example, the client program, may receive a parent account login (step 401). A parent login is an authentication of a user that has at least authority to install programs to the student PC. Next, the client program may acquire an EBP video game software (step 403). Step 403 may be responsive to the parent account login or its equivalent. The EBP video game software may be acquired in several different ways. As an example, the EBP video game software may be obtained on a recordable device. Alternatively the EBP video game software may be obtained as a download of machine instructions, data files, configuration files, and the like. Such a download can be, for example, from server 308 of FIG. 3. In the latter case, the student PC may receive the EBP video game as a download.

The client program installs the EBP video game to the student PC (step 405). Such an installation may be responsive to user inputs and selections. In other words, the client program can respond to instructions from the parent or other users to store software to non-volatile storage, such as, for example, hard drives, solid state drives, etc. Next, a parent may enter the student pass-code for his child or student. Accordingly, the client program may associate a lesson plan pass-code with at least one student account (step 407). Accordingly, each student pass-code can be registered with each student so that each student can benefit later when playing the EBP video game. In other words, the student PC, having received a student's login to the local machine, may rely on the previously associated pass-code to communicate student identity when accessing a server. At the time the student plays the EPB video game, the student PC will provide the pass-code for the student to be used to locate a corresponding lesson plan pass-code stored on a server. Thus, the student can rely on a matching process at the server to initially, locate a lesson plan (and thus, obtain questions for use when playing his video game). In addition, once the lesson plan is selected, the server can focus the student on making choices of video games associated with the lesson plan.

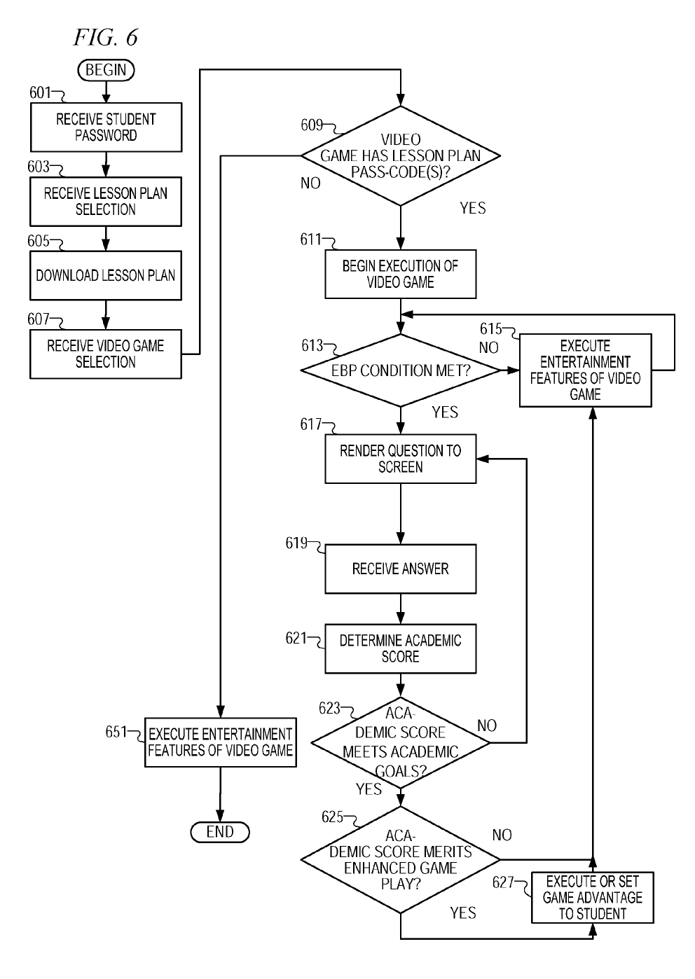

Under one scenario, the student accesses the educational server web site and enters a student identity to identify the student. In response to the student identity and prior specification by the teacher of a certain set (or sets) of educational questions for that student for the teacher's class (based on the lesson-plan pass-code), the educational server identifies a proper set or list of proper sets of educational questions, respective correct answers and associated academic goals for that student. The set or sets can be as described above, the one or more lesson plans available to the student. If there is a list of lesson plans, then the student selects the set that the student wants to include in the video game during current play. Then, the student PC obtains the video game with the break points either from a disk or downloaded from the manufacturer. By way of using the embodiment of FIG. 6, below, in the process of executing the client program on the student PC, the student PC obtains the educational questions, as well as answers and educational goals, from the educational server and presents the educational questions at the break points. The break points occur in sequence. The sequence depends on the student's inputs in non-linear games, however, in games where a plot unfolds sequentially, the break points may occur in a specified order. A break point is the occurrence of conditions that permit rest between game events. In some games, the break point can be a point where a student reaches another level of game-play.

Accordingly, the respective educational questions are numbered consecutively to indicate an order with which the educational questions are presented. Likewise, the respective answers are correlated to the respective questions so the client program can determine if the student answered the questions correctly. The client program can be included in the video game or previously downloaded from the educational server and installed on the student PC. The video game includes a list of break points and code to implement possible modifications to game play, such as application of rewards and penalties to the student's current game play based on whether the student answers the questions correctly or incorrectly.

In response, the client program receives the academic goal and sets the academic goal, with respect to the student account (step 409). Next, the student plays the video game which pauses at the break points to present the respective educational questions to the student and receive entry of respective answers from the student. Preferably, the success or failure of the student in answering the questions yields a respective reward or penalty in the student's play of the video game. The reward can be some type of advantage in the play and conversely, the penalty can be some type of disadvantage in the play. The rewards and penalties correspond to the nature of the video game being played and the manufacturer of the game builds-into the program code various rewards and penalties that can be applied. For example, in a video game where the student controls a character in some type of competition, a “reward” will result in the character having extra skills, powers, tools, time to complete a challenge, etc. and vice versa. For example, if the student answers a question correctly, the student can be given additional ammunition in a combat game or additional game time or attempts to achieve a predetermined objective. As another example, if the student answers a question correctly and/or attains an academic goal, the student can be awarded some other type of privilege in the form of an enhancement to video game play. An academic goal is a goal that is used to allocate video game privileges to a student by setting a threshold of academic scores that a student must meet before receiving either the enhancement to video game play, or permission to use any entertainment feature of an EBP video game. An entertainment feature is any graphic or sound effect. An entertainment feature can be, for example, ballistic movement, maze movement, elimination of obstacles, capture of goals, avoidance of falls, construction, race navigation, obtaining sets, segue between levels, design of character, outfit of character, narration, score animation, and the like. Sound effects can include vibration or other tactile effects.

Subsequently, the client program may receive a logout command, and accordingly, logout (step 411).

FIG. 5 is a flowchart of lesson plan distribution in accordance with an illustrative embodiment of the invention. Initially, an educator or student may enter or update details for a lesson plan. Accordingly, a PC, for example, teacher's PC 305 of FIG. 3, may generate a lesson plan (step 501). Teacher program 333a is stored in computer-readable disk storage 333b for execution by processor(s) 333d via computer readable RAM 333c (see FIG. 3). As such, the teacher program may receive an academic goal specified by the teacher in the lesson plan among the other lesson plan data entered by the teacher. Any academic goal set at this point may be set as a default, and thus may be modifiable at a later point by a parent or guardian. Next, the teacher program may record a pass-code and expiration date corresponding to the lesson plan (step 503).

Next, the teacher program may store the lesson plan to a lesson plan repository (step 505). The repository can be a remote repository located outside the teacher PC. The remote repository can be, for example, lesson plan database 309 of FIG. 3. The repository can be located in an educational institution, in a data center remote from the educational institution, or in any place remote from the teacher PC. Accordingly, the repository can be at a server that relies on access control to authenticate and limit a user's access to the server, including lesson plans stored therein. Thus, storing the lesson plan can include a repository receiving the lesson plan as well as the academic goal stored therein. Next, the teacher program may distribute pass-codes to a guardian in charge of a student (step 507). One way to distribute the pass-codes is to send an email to an email address of a guardian. Alternatively, the pass-codes may be distributed by a website hosted at a server.

In one illustrative embodiment, a parent adds or modifies an academic goal either at a repository, or within a student PC. This feature can permit a parent to tailor goals to match the goals of the parent—or alternatively, the student's zeal at playing video games.

In one illustrative embodiment, educators, or other people employed by an educational institution, have exclusive access to create lesson plans. Alternatively, a student may create his own lesson plans as well as set her own academic goals by setting thresholds that determine if a sufficiently high academic score will trigger additional game play. In this second illustrative embodiment, the student may be particularly self-motivated to assure regular exposure to educational materials in the lesson plan or plans. The student may author a lesson plan by creating a new file using a suitable editor executing in the student PC, or by editing an existing file using the editor. Accordingly, by relying on the editor, the student may author a lesson plan. Accordingly, the student can self-author, for example, a spelling test, which will help remind the student later, during class-room testing, the correct way to spell words

FIG. 6 is a flowchart of a video game interaction with a student and lesson plan in accordance with an illustrative embodiment of the invention. As such, the flowchart shows execution of a data processing system, such as a student PC, in a manner that allows it to execute instructions of the client program to check whether EBP conditions are met, based on criteria set by the software designer who authors the game. Responsive to such conditions being met, the video game may lookup details in a lesson plan in order to modify game play accordingly. An EBP condition is a state of the EBP video game that meets criteria set by the EBP video game maker. The state can be the status of registers, data structures and/or I/O signals that signal a transition in game play. The EBP condition can be associated with a point in a video game where a natural break might be taken. There are several examples of EBP conditions. First, in a football game simulation, an EBP condition can be a determination of whether a football play has concluded, for example, by the ball carrier being ruled as down, or the football being thrown out of bounds. Accordingly, when a play is determined to be done, the EBP condition is considered to be met. A second example can be in the context of a racing game involving laps. When a car or other vehicle passes the finish line, the EBP condition is considered to be met. A third example of an EBP condition can be applied in a simulated basketball game. When a player shoots a basket, or is fouled when shooting, an EBP condition can be considered to be met. Many other EBP conditions can exist and will be manifested in the many forms that video game play can take.

Initially, the client program may receive the student password from the student (step 601). A student password is a secret identifier that is shared between the student and the student PC. Next, the client program may receive a lesson plan selection from the student (step 603). The student can select among one or more descriptions of the lesson plan. The lesson plan can be described in the language of the student, for example, using a chapter name that the student is studying. The lesson plan description can be a default setting, for example, where a single teacher participates in providing lesson plans, or where parents select a single subject for a student to focus on. Next, the client program may download the lesson plan from a server (step 605). Downloading can occur in a piecemeal fashion, where the student PC looks up details on a remote server on an episodic basis.

Next, the client program may receive a video game selection from the student (step 607). The video game selection may be a selection made by the student of a video game installed to the student PC. Next, the client program determines from the server whether the video game selected has associated lesson plan pass-codes corresponding to the lesson plan downloaded earlier (step 609).

If the determination is positive, then the client program begins executing the video game (step 611). The client program may determine if an EBP condition is met (step 613). If the EBP condition is not met, the client program executes an entertainment feature of the video game (step 615). In other words, when the natural break has not occurred in the video game, the video game continues to produce activity to entertain the student. Periodically, the client program checks again whether the EBP condition is met at step 613. Responsive to the EBP condition being met, the client program may render an education question to the screen (step 617). A screen is a display that can be operatively coupled to graphics processor 110 of FIG. 1. Next, the client program may receive an answer (step 619). The answer may be given by a student using a game controller, keyboard, or the like. Next, the client program may determine an academic score (step 621). Correct answers are given a weight based on weights established in the lesson plan. For example, a formula can rely on variables such as previous score (P), points possible for current question (Wᵢ), and status of the answer (Aᵢ) as correct (1) or incorrect (0). Such a formula for determining scores can be

$${S}_{i} = ( P + {W}_{i} {A}_{i} ) / {\sum }_{n = 1}^{1} {W}_{n} {A}_{n}$$

for all questions 1 through i, where ‘i’ is the current serial number of the last question answered. In the weight system, questions having a weight of ‘1’ can be scored with 10 points each, while questions having a weight of ‘9’ can be scored with 2 points each. A previous score can be the sum of all previous answers, i.e. those answers not including ‘i’, prior to the current answer:

$$P = {\sum }_{n = 1}^{i - 1} {W}_{n} {A}_{n} .$$

Next, the client program determines whether an academic score meets the academic goals set by an educator and/or guardian (step 623). In other words, a test can be performed to see if Sᵢ>G, where G is the academic goal set earlier. If the academic score is not met, step 617 may be repeated. Otherwise, the client program may determine whether the academic score merits enhanced game play (step 625). If the academic score merits enhanced game play, the client program may execute or set a game advantage to the student (step 627). A game advantage can be for example, advantaged position in a game environment, a power-up, extra lives, or any other useful game feature that enables greater progress or more stimulating play. Execution can continue at step 615.

A meritorious score is a score that passes a threshold used in step 625. A manufacturer may release a video game, thereby preselecting either the threshold, the particular game advantage or both that correspond to the EBP condition. Accordingly, the educational question may be assigned a game advantage based on the student earning a sufficiently high academic score at the right time in the video game play, as measured against a pre-set threshold. The manufacturer can be a maker of the devices on which instructions for an EBP video game may be placed. The manufacturer can be a software designer that authors the instructions, configuration, or data of the EBP video game.

Game advantages can include, for example, an opportunity to ‘do-over’ a football play in a football simulating video game. Such an opportunity can be helpful if the player operates a video game team that threw an interception in the video game. Other possible changes can increase a simulated athlete's abilities, for example, running faster or jumping higher. Game advantages will vary according to the game goals and circumstances.

Absent an academic score sufficiently high to yield a positive result at step 625, the student PC continues to execute at step 615. In some embodiments, a reduction in game play features can occur or difficulty can increase in response to a negative result at step 625. Reduction in play can be a diminished feature or penalty. A diminished feature or penalty delays or obstructs game progress for the student or player. For example, a penalty for a low academic score or incorrect question can be following a play in which a fumble was recovered by the player's team, the fumble is recovered by the opposing team. In other words, as a consequence, the alternate history of the game can change possession of the ball to the opponent. Alternatively, a player can lose a time-out that previously had been allocated to the player's team.

To the extent that the student PC hosts video games that are not associated with a lesson plan pass-code, step 609 assures a negative result triggers the student PC executing entertainment features of the video game (step 651). Processing terminates thereafter.

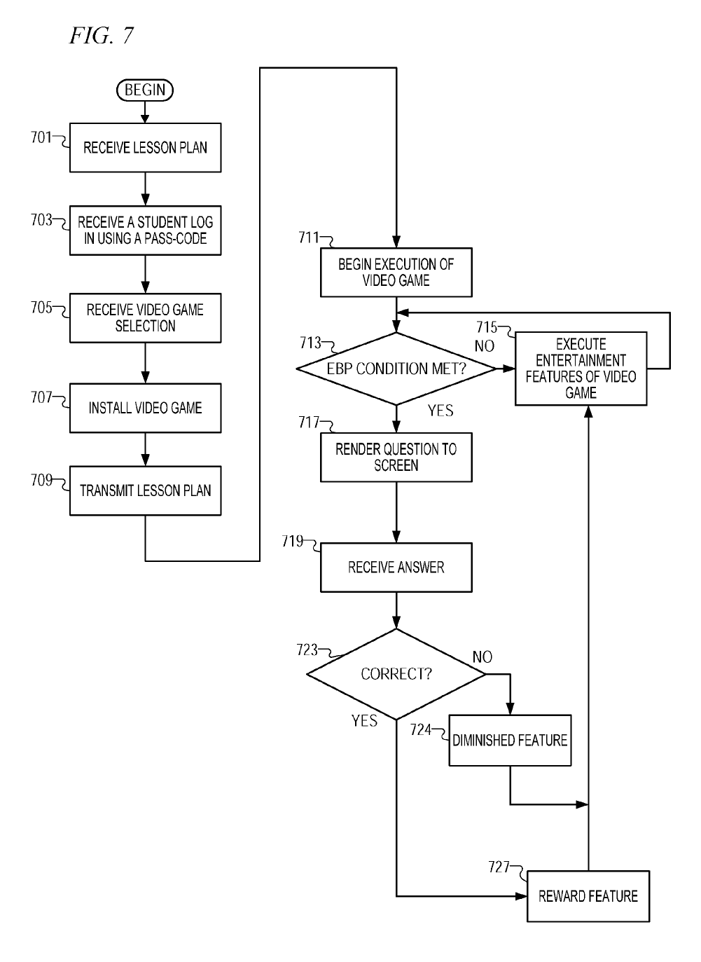

FIG. 7 is a flowchart of steps of a lesson plan server in accordance with an illustrative embodiment of the invention. Lesson plan program 383 is stored in computer-readable disk storage 383b for execution by processor(s) 383d via computer readable RAM 383c, as shown in server 308 server FIG. 3. Server 308 may store, in addition to a lesson plan database, a set of video games or obtain these as requested by students by download from the manufacturer of the video games. When a student accesses the server based on a specific lesson plan, the server executing the lesson plan program can limit video games to those that have enough breakpoints to match each academic question of the lesson plan.

Initially, the lesson plan program may receive lesson plans (step 701). The lesson plans can be from an educator and may include a set of educational or academic questions. Since the lesson plan program can collect and retrieve many lesson plans, the lesson plan program can receive plural lesson plans from multiple educators corresponding to many students. Next, the lesson plan program may receive a student log in using a pass-code (step 703). If multiple students are playing the same video game, then multiple log ins may be received at step 703, for example, from a first student and from a second student. Next, the lesson plan program may receive a video game selection (step 705). Accordingly, the video game, thereby selected, may become associated, at least for the following game-playing session, with the one or more pass-codes of the student(s), thus forming at least one lesson plan pass-code of the video game. The video game selection can be a packet transmitted by a request from a student PC. The video game selection can be limited, for example, to a set of video games that are linked or otherwise based on a lesson plan for the student. Next, the lesson plan program may install, download and/or render a video game (step 707). This step can include transmitting the video game to a student PC. Next, the lesson plan program can transmit the lesson plan (step 709). This step may be performed by looking up the lesson plan within the lesson plan database 309. Moreover, multiple lesson plans can be transmitted to a single student PC, for example, when multiple students are each relying on the look-up of the lesson plans that correspond to each student.

The lesson plan program may continue by executing the video game (step 711). The lesson plan program may determine if an EBP condition is met (step 713). If the EBP condition is not met, the lesson plan program executes an entertainment feature of the video game (step 715). Periodically, the lesson plan program checks again whether the EBP condition is met at step 713. Responsive to the EBP condition being met, the lesson plan program may render an education question to the screen (step 717). A screen is a display that can be operatively coupled to graphics processor 110 of FIG. 1. Next, the lesson plan program may receive an answer (step 719).

Next, the lesson plan program determines whether the answer is correct (step 723). If the answer is incorrect, continued game play may be executed using a diminished feature (step 724). Otherwise, the lesson plan program may determine a correct answer is given, and execute further game features with a reward feature (step 727). Execution can continue at step 715, following either steps 724 and 727.

It is appreciated that step 707 can be implemented in many forms in tandem with steps 715 and 727. For example, in an embodiment where rendering of a game is transmitted from server to student PC, many game steps can be executed on the server, the student PC, or both. Alternatively, the server may merely download executable elements of the video game to the student PC, and the student PC may obtain, by request, each academic question in response to educational break point conditions occurring.

It is appreciated that a video game can be associated to two or more sets of educational questions, and thus can be played by two students where each student has a distinct lesson plan from the other. Accordingly, in multiplayer games, such as where two students can take turns in using the video game, distinctive questions can be asked to each student during, for example, competitive game play.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable device providing program code for use by or in connection with a computer or any instruction execution system.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or computer readable tangible storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for regulating game play in a video game, the method comprising:
a computer receiving from a teacher an academic goal corresponding to a lesson plan for a multiplicity of students, the academic goal corresponding to a first set of educational questions to present to the students at respective break points occurring during play of the video game;
the computer authorizing a parent of one of the students to modify the academic goal for the one student but not for an other of the students, and afterwards receiving from the parent of the one student a modification to the academic goal for the one student but not for the other of the students, and in response, the computer correlating the modified academic goal for the one student to a second, different set of educational questions to present to the one student at the respective break points occurring during play of the video game, the second set of educational questions for the one student differing from the first set of educational questions presented to the other of the students at the break points;
in response to a request by the one student to play the video game, the computer executing the video game;
in response to occurrence of one of the break points during execution of the video game for the one student, the computer presenting to the one student one question of the second set of questions, the one question of the second set differing from a question presented to another of the students at the one break point;
in response to an answer received from the one student to the one question of the second set, the computer updating an academic score for the one student to the second set of questions and if the answer is a correct answer, implementing a new game advantage to the one student during continued play of the video game, and if the answer is incorrect, not implementing the new game advantage to the one student during continued play of the video game, wherein the new game advantage is an advantage in the manner the video game is played to the benefit of the one student.

2. The method for regulating game play of claim 1, further comprising:
in response to receiving an incorrect answer from the one student to the one question of the second set, implementing a new game disadvantage.

3. The method for regulating game play of claim 1, wherein receiving from a teacher an academic goal further comprises receiving an expiration date corresponding to the lesson plan.

4. The method for regulating game play of claim 1, wherein authorizing a parent of the one students further comprises distributing a parent pass-code to the parent; and
wherein the computer executing the video game is in response to receiving a student pass-code to identify the one student corresponding to the parent pass-code.

5. The method for regulating game play of claim 4, wherein the computer executing the video game is in response to receiving the student pass-code and receiving the first set of education questions, and the first set of educational questions corresponds to the student pass-code.

6. A computer program product for regulating game play in a video game, the computer program product comprising:
one or more computer readable storage devices and program instructions, stored on the one or more storage devices, the program instructions comprising:
program instructions to receive from a teacher an academic goal corresponding to a lesson plan for a multiplicity of students, the academic goal corresponding to a first set of educational questions to present to the students at respective break points occurring during play of the video game;
program instructions to authorize a parent of one of the students to modify the academic goal for the one student but not for an other of the students, and afterwards receiving from the parent of the one student a modification to the academic goal for the one student but not for the other of the students, and in response, correlating the modified academic goal for the one student to a second, different set of educational questions to present to the one student at the respective break points occurring during play of the video game, the second set of educational questions for the one student differing from the first set of educational questions presented to the other of the students at the break points;
program instructions to execute the video game, in response to a request by the one student to play the video game;
program instructions to present to the one student one question of the second set of questions, the one question of the second set differing from a question presented to another of the students at the one break point, in response to occurrence of one of the break points during execution of the video game for the one student;
program instructions to update an academic score for the one student to the second set of questions and if the answer is a correct answer, implementing a new game advantage to the one student during continued play of the video game, and if the answer is incorrect, not implementing the new game advantage to the one student during continued play of the video game, in response to an answer received from the one student to the one question of the second set, wherein the new game advantage is an advantage in the manner the video game is played to the benefit of the one student.

7. The computer program product for regulating game play of claim 6, further comprising:
program instructions to implement a new game disadvantage, in response to receiving an incorrect answer from the one student to the one question of the second set.

8. The computer program product for regulating game play of claim 6, wherein the program instructions to receive from a teacher an academic goal further comprises program instructions to receive an expiration date corresponding to the lesson plan.

9. The computer program product for regulating game play of claim 6, wherein program instructions authorize a parent of the one students further comprises program instructions to distribute a parent pass-code to the parent; and
wherein program instructions to execute the video game is in response to receiving a student pass-code to identify the one student corresponding to the parent pass-code.

10. The computer program product for regulating game play of claim 9, wherein the program instructions to execute the video game is in response to receiving the student pass-code and receiving the first set of education questions, and the first set of educational questions corresponds to the student pass-code.

11. A computer system for regulating game play in a video game, the computer system comprising:
one or more processors, one or more computer-readable memories, one or more computer-readable storage devices and program instructions, stored on the one or more storage devices for execution by the one or more processors via the one or more memories, the program instructions comprising:
program instructions to receive from a teacher an academic goal corresponding to a lesson plan for a multiplicity of students, the academic goal corresponding to a first set of educational questions to present to the students at respective break points occurring during play of the video game;
program instructions to authorize a parent of one of the students to modify the academic goal for the one student but not for an other of the students, and afterwards receiving from the parent of the one student a modification to the academic goal for the one student but not for the other of the students, and in response, correlating the modified academic goal for the one student to a second, different set of educational questions to present to the one student at the respective break points occurring during play of the video game, the second set of educational questions for the one student differing from the first set of educational questions presented to the other of the students at the break points;
program instructions to execute the video game, in response to a request by the one student to play the video game;
program instructions to present to the one student one question of the second set of questions, the one question of the second set differing from a question presented to another of the students at the one break point, in response to occurrence of one of the break points during execution of the video game for the one student;
program instructions to update an academic score for the one student to the second set of questions and if the answer is a correct answer, implementing a new game advantage to the one student during continued play of the video game, and if the answer is incorrect, not implementing the new game advantage to the one student during continued play of the video game, in response to an answer received from the one student to the one question of the second set, wherein the new game advantage is an advantage in the manner the video game is played to the benefit of the one student.

12. The computer system for regulating game play of claim 11, further comprising:
program instructions to implement a new game disadvantage, in response to receiving an incorrect answer from the one student to the one question of the second set.

13. The computer system for regulating game play of claim 11, wherein the program instructions to receive from a teacher an academic goal further comprises program instructions to receive an expiration date corresponding to the lesson plan.

14. The computer system for regulating game play of claim 11, wherein program instructions authorize a parent of the one students further comprises program instructions to distribute a parent pass-code to the parent; and
wherein program instructions to execute the video game are in response to receiving a student pass-code to identify the one student corresponding to the parent pass-code.

15. The computer system for regulating game play of claim 14, wherein the program instructions to execute the video game are in response to receiving the student pass-code and receiving the first set of education questions, and the first set of educational questions corresponds to the student pass-code.
